(19) United States
(12) Patent Application Publication
(10) Pub. No.: US 2026/0022525 A1
(43) Pub. Date: Jan. 22, 2026

(54) CLEANER MODULE

(71) Applicant: Yo Han KIM, Pyeongtaek-si, Gyeonggi-do (KR)

(72) Inventor: Yo Han KIM, Pyeongtaek-si, Gyeonggi-do (KR)

(21) Appl. No.: 18/992,867

(22) PCT Filed: Jul. 30, 2022
(86) PCT No.: PCT/KR2022/011258

§ 371 Date: Jan. 9, 2025

(30) Foreign Application Priority Data
Jul. 9, 2022 (KR) 10-2022-0084697

(51) Int. Cl. E01H 1/08; G05D 3/12

(52) U.S. Cl. CPC E01H 1/0863; G05D 3/12

(57) ABSTRACT

A cleaner module is disclosed. A system is a suction device for cleaning a road surface, which is combined with a vehicle, the system comprising: a spraying member that increases air volume; a dustpan that moves the suction device near the road surface by using a lifting device, serves as a guide for suctioned FO, and controls the gap with the road surface; a transfer device that uses a vacuum; an FO sensor that controls the transfer device; a controller, and a storage tank.

### TECHNICAL FIELD

The present disclosure relates to a cleaner module and, more particularly, to a suction device for cleaning a road surface.

### BACKGROUND ART

A road surface cleaning vehicle generates a vacuum negative pressure with a turbofan suctioning air of a dust storage tank and lowers a suction tube to a road surface to raise and remove dust on the road surface to the storage tank. When a component of the road surface cleaning vehicle interferes with the structure of the vehicle, the sucked foreign object (FO) falls due to the long and inclined suction tube. When the vehicle is moved, since an inlet of a suction device is operated to be raised to prevent interference between the inlet of the suction device and the road surface or to be lowered for cleaning work, a flexible bellows tube may be used in the suction tube. The bellows tube has suction resistance due to unevenness inside the tub. When the vehicle performs cleaning work, due to the lack of suction capacity of the road surface cleaning vehicle, the suctioned FO does not reach the dust storage tank mounted to an upper portion of the vehicle body or is caught in the bellows tube used as the suction tube and then falls back on the road surface after the device operations is stopped.

### DISCLOSURE

### Technical Problem

An objective of the present disclosure is to provide a technical solution to solve the lack of suctioning capacity of a road surface cleaning vehicle.

Another objective of the present disclosure is to provide a technical solution to solve the leakage of an FO from a cleaning device.

### Technical Solution

In order to achieve the above objectives according to an aspect, the cleaner module includes a frame supporting components, a slide frame having a lifting device cylinder, which allows a suction device to protrude rearward of a vehicle storage tank and be lowered, a sensor measuring a distance with a road surface, a controller controlling a gap with the road surface to be maintained, a dustpan driving cylinder, a dustpan driving lot, a dustpan, a transfer device disposed between an inlet passage and a first storage tank, a transfer device rotated with a worm and worm gear when a transfer device driving motor is operated, a tone wheel and a sensor disposed at one portion of a transfer device driving shaft, a controller controlling the tone wheel when the tone wheel deviates from a stop position when the transfer device driving motor is operated according to a desired control and controlling the sensor to be rotated until the sensor reaches a next stop position and be stopped, a suction device having an inlet that is the transfer device disposed at a side surface and an outlet disposed at an upper portion, and a first storage tank in which a vacuum formed when a turbofan discharges air is maintained when the transfer device is opened by the controller, which suctions an FO collected at the first storage tank inlet in a way of sweeping the FO with a vacuum formed in the first storage tank and an upper portion of the transfer device is rotated forward, and a spraying member including a shroud amplifying a wind flow of air left after the turbofan generates a vacuum in the first storage tank and the inlet by drawing surrounding air and spraying the air to a target point of the road surface to guide a flying FO into the inlet of the suction device along an inclination of the dustpan to the transfer device inlet. When the vehicle is moved, a swing arm raises the spraying member to reduce interference when the vehicle is moved, and when cleaning work is performed, the swing arm lowers the spraying member near the road surface, so when an FO is suctioned, the FO is classified while passing through the inlet, and an light FO is caught by a filter of the storage tank and an FO staying in the first storage tank inlet is moved into the first storage tank due to operation of the transfer device and is removed.

### Advantageous Effects

According to the present disclosure, through the spraying member and the suction device that is moved to a lower height, the dustpan that controls a gap with the road surface and serves as a guide during suctioning, the first storage tank storing a vacuum pressure, and the transfer device periodically operated and transferring an FO into the first storage tank in which a vacuum is formed, FO suctioning performance of the cleaner module can be improved and, specifically, when operation is stopped, the dustpan blocks the inlet to prevent leakage of FO.

### DESCRIPTION OF DRAWINGS

FIGS. 1 and 2 are perspective views illustrating the configuration of a cleaner module according to an embodiment.

FIG. 3 is a side view illustrating the configuration of a lifting device according to the embodiment.

FIG. 4 is a section view illustrating a controller of a transfer device according to the embodiment.

FIG. 5 is a front view illustrating a suction device according to the embodiment.

FIG. 6 is a view illustrating a position example of a dustpan when the cleaner module is stopped in a section taken along line I-I of FIG. 5 according to the embodiment.

FIG. 7 is a block diagram of FO processing according to the embodiment.

FIGS. 8 to 11 are views illustrating examples of a processing method during suctioning FO in sections taken along lines I-I and II-II of FIG. 5 according to the embodiment.

FIG. 12 is an exploded view illustrating a suction device according to the embodiment.

FIG. 13 is a partially enlarged view of a dustpan driving part according to the embodiment.

FIG. 14 is a perspective view illustrating the spraying member according to the embodiment.

FIG. 15 is a view illustrating an example of an air flow in section I-I of the spraying member according to the embodiment.

FIG. 16 is a view illustrating an example of application of according to the embodiment the spraying member

### BEST MODE

### Mode for Invention

The above-described and additional aspects of the present disclosure will be clearer through embodiments described with reference to accompanying drawings. Hereinbelow, preferred embodiments of the present disclosure will be described in detail to facilitate understanding and implementation by those skilled in the art.

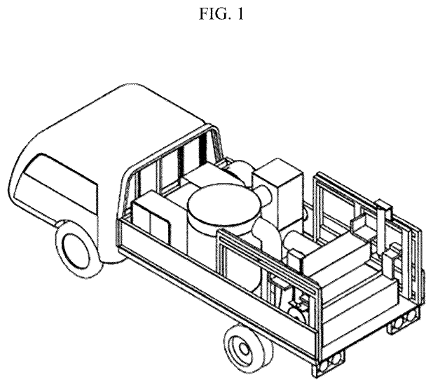

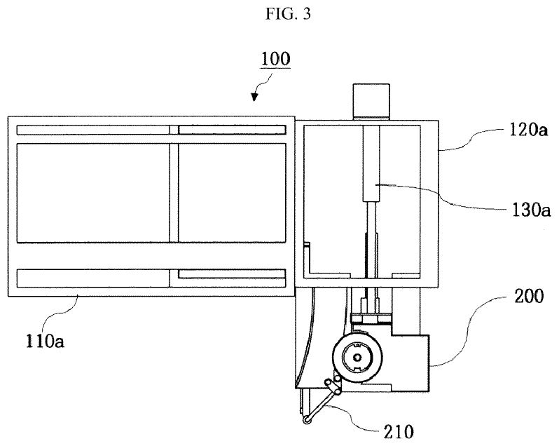

As illustrated in FIGS. 1 to 3, according to the embodiment, a lifting device 100 includes a pair of frames 110 fixed to a storage tank of a vehicle, a pair of slide frames 120 coupled to the pair of frames 110 and moved freely forward and rearward, and a pair of lifting device cylinders 130 coupled to the pair of slide frames 120. A suction device 200 protrudes by the pair of slide frames 120 in a rearward direction of the vehicle and is lowered by the pair of lifting device cylinders 130. When the vehicle is moved, the suction device 200 is loaded up by the lifting device 100 and fixed to the storage tank, and when the vehicle performs cleaning work the lifting device 100 lowers the suction device 200 to a lower height.

A suctioned FO is moved through an inlet 221D and directly to a filter 30 of the storage tank.

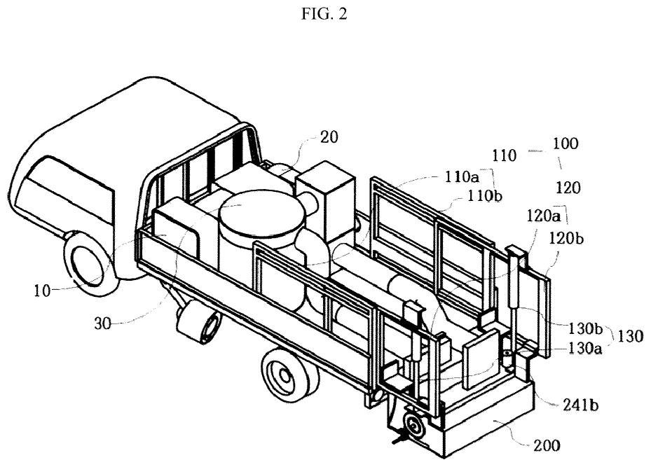

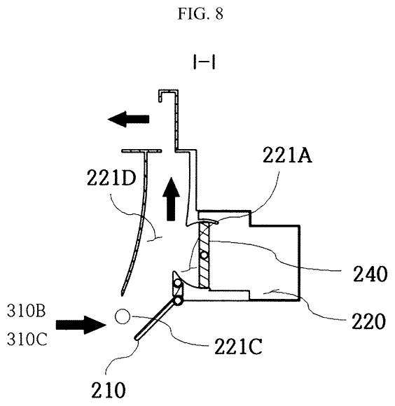

As illustrated in FIG. 2 or 4 or FIGS. 7 to 11, when the heavy FO 221C is suctioned, the FO 221C stays at a first storage tank inlet 221A.

When a transfer device 240 is operated, an upper portion of the transfer device 240 rotates forward and sweeps up the FO 221C collected at the first storage tank inlet 221A toward the first storage tank 220.

The first storage tank 220 is arranged in parallel to the inlet 221D, and air discharge of the turbofan 20 creates a vacuum to be applied therein. When a controller 10 drives a transfer device driving motor 241 to control the closed transfer device 240, a worm and worm gear 230 rotates a transfer device driving shaft 240a. When a tone wheel 251 connected to the transfer device driving shaft 240a deviates from a stop position, the controller 10, which rotates the worm and worm gear 230 until a sensor 250 detects that the tone wheel 251 reaches a next stop position and then stops the worm and worm gear, allows the transfer device 240 to release a vacuum formed in the first storage tank 220 and the upper portion of the transfer device 240 of a swing door shape to rotate forward and a lower portion to sweep toward the first storage tank 220, thereby removing the FO 221C collected at the first storage tank inlet 221A.

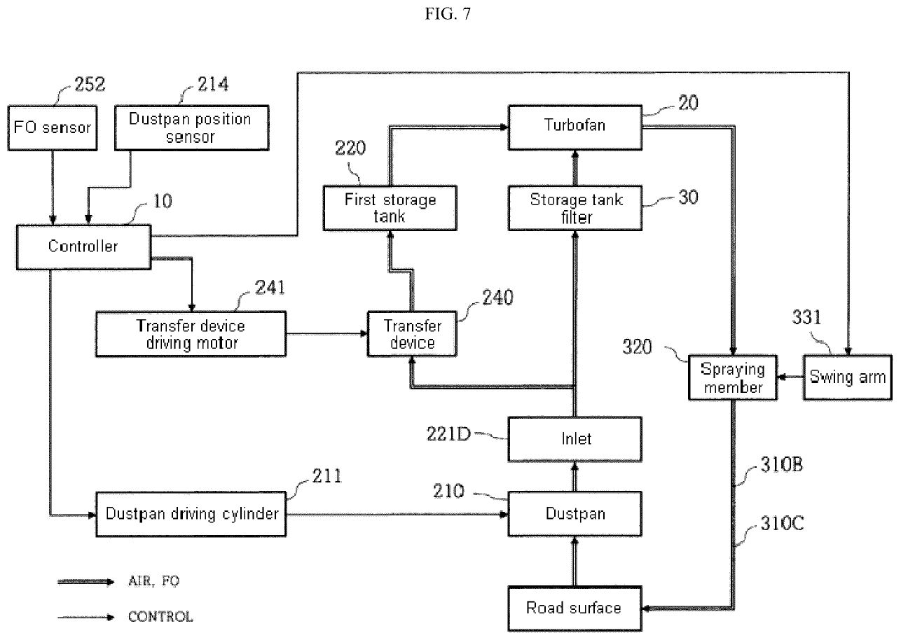

The above application of the cleaner module according to the embodiment allows the FO 221C to be removed from the inlet 221D through the application and, as shown in FIG. 6, the dustpan 210 to be moved to a closed position during stopping, thereby preventing leakage of the FO 221C doubly.

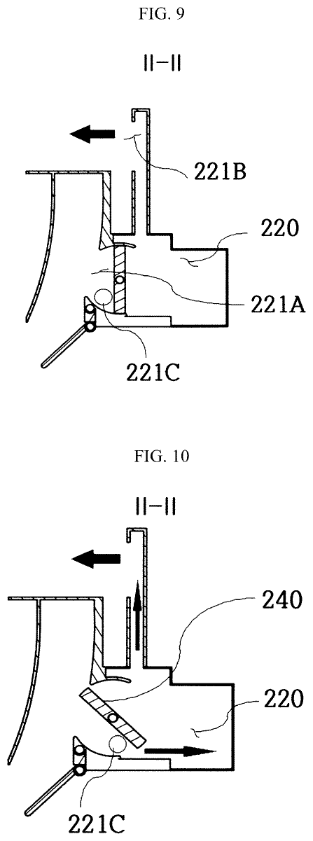

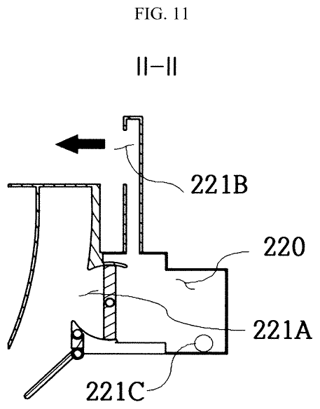

The present disclosure will additionally be described in the diagram in FIG. 7. An air flow is generated from the turbofan 20 to a spraying member 320. The air flow 310B generated from the spraying member 320 and an air flow 310C generated in a direction in which the vehicle is moved forward are added, and when the FO exists on the road surface, the FO is pushed into the inlet 221D along the inclination of the dustpan 210. A light FO that is easily suctioned is caught by the storage tank filter 30 while passing through the inlet 221D. As illustrated in FIG. 9, when a heavy FO 221C does not pass through the inlet 221D, the FO 221C is caught by a groove of the first storage tank inlet 221A according to suction inertia and travel speed of the vehicle. Since the turbofan releases air from the first storage tank 220 and generates a vacuum, as illustrated in FIGS. 10 and 11, when the transfer device is opened and closed periodically, the heavy FO 221C caught at the first storage tank inlet 221A is moved into the first storage tank 220 and is removed.

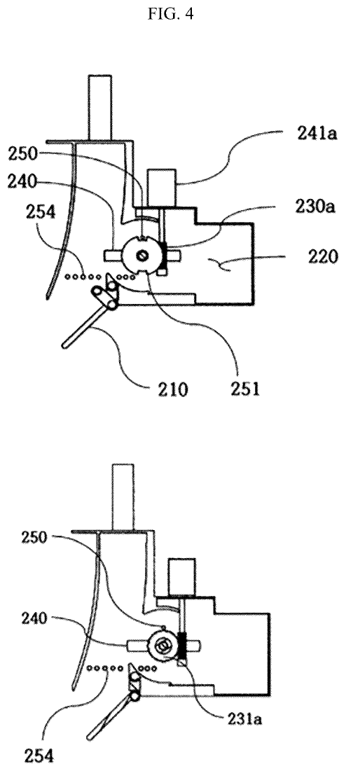

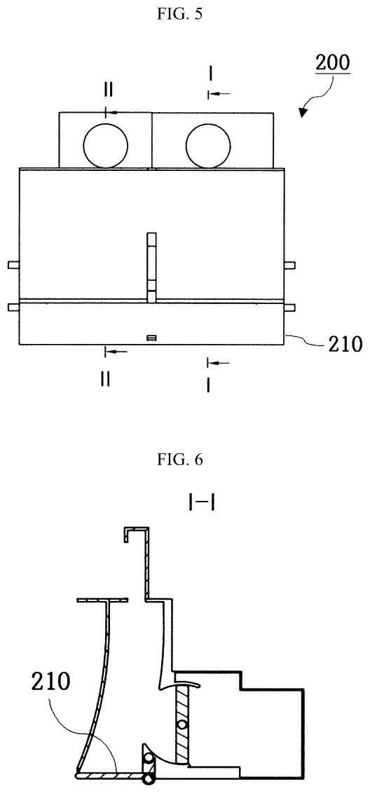

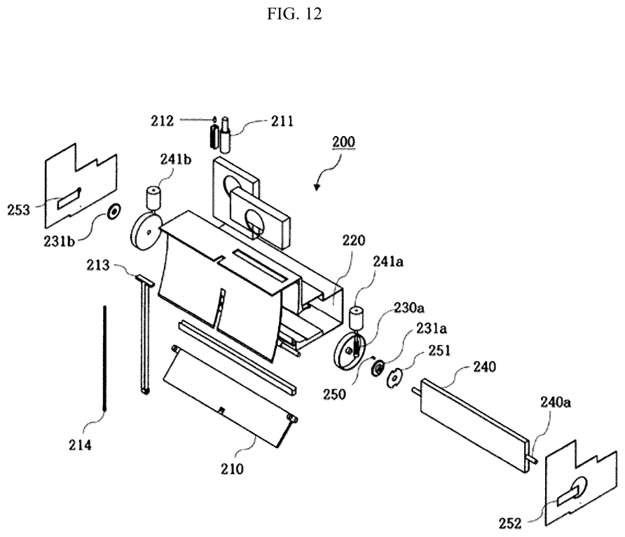

As illustrated in FIG. 4 or 12, the suction device 200 may include a laser including a receiver 252 and a transmitter 253 for detecting an FO or a grid-shaped sensor consisting of infrared rays, etc. A passage through which rays such as a laser or infrared rays pass is called a detection part. In FIG. 4, an FO passing through the detection part 254 blocks light emitted from the transmitter 253 to change a state of the receiver 252. When the FO passes through the detection part 254, a state that is logically 0 is changed into 1 or a state that is logically 1 is changed into 0, and a value thereof may be calculated. Therefore, the receiver 252, the transmitter 653, and the detection part 254 may collectively be called the FO sensor, but a value used in the calculation is a value changed in the receiver 252, so the value is indicated as the FO sensor 252 in FIG. 7. As illustrated in FIG. 4, the FO sensor is arranged such that the detection part 254 is transversely arranged to the inlet 221D and the first storage tank inlet 221A, the receiver 252 is mounted to a left cover of the suction device 200, and the transmitter 253 is mounted to a right cover of the suction device 200. According to the embodiment, the FO sensor is 8BIT of 0 and 1, and when an FO is detected, a value of 0 is changed into 1, and 5 BIT is arranged at the inlet 221D, and 3BIT is arranged at the first storage tank inlet 221A. 3BIT of the first storage tank inlet 221A is detected as a value that is not 0, it is determined that the heavy FO is collected, and a weighted value is added to the value to determine whether the transfer device 220 is operated.

Furthermore, the controller 10 may store a BIT value when the FO sensor detects an FO into memory of an internal database or transmit outward, and may include location information and time information when an FO is detected. When the FO sensor of 8BIT expands more than 8BIT and the number of rays of the detection part 245 with the same width increases, an FO with a smaller size may be detected. However, according to the embodiment of the present disclosure, the width of the inlet 221D is considered to increase the processing efficiency of a heavy FO, and the width of the detection part 254 is preset to detect an FO more than a predetermined size, and this is not to limit the number of BIT of the FO sensor and is only an example for detecting and processing an FO.

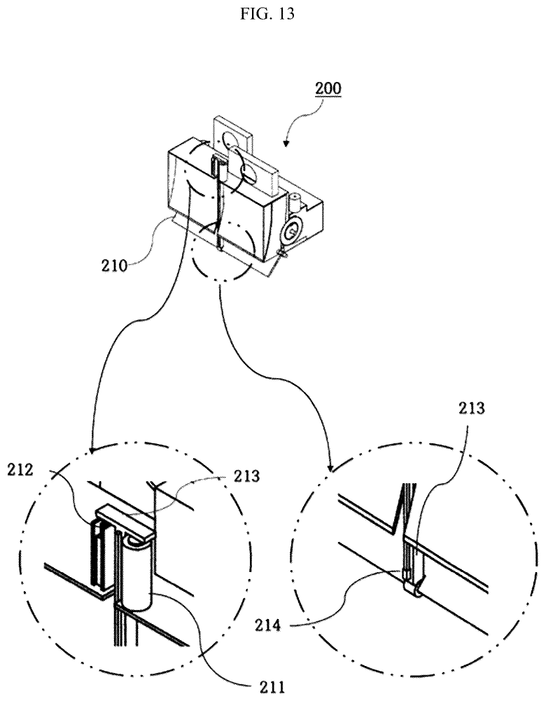

A driving member of the dustpan 210 will be described. As illustrated in FIGS. 12 and 13, one or more types of sensors are mounted to a dustpan driving lot 213, which does not limit a type of sensor and a mounting location thereof, and various modifications, equivalents, additions, and substitutions are possible by those skilled in the art, without departing from the scope and spirit of the present disclosure. A first portion of the dustpan driving lot 213 is coupled to the dustpan 210 and a second portion thereof is placed over a dustpan driving cylinder 211. A sensor 214 mounted to a lower portion of the dustpan driving lot 213 measures a distance between the road surface and the dustpan to serve a purpose of safety that prevents a collision between the road surface and the dustpan 210 and a purpose that increases the efficiency of the cleaner module by maintaining a constant distance between the road surface and the dustpan 210. Since the dustpan driving lot 213 is not fixed to the dustpan driving cylinder 211, when an impact such as a collision with the road surface is applied, the dustpan driving lot 213 may deviate from the dustpan driving cylinder 211 and be raised with the dustpan 210, thereby serving a protection function against an impact. When the dustpan driving cylinder 211 is operated with a value calculated by the controller 10, the dustpan 210 is raised or lowered by the dustpan driving lot 213.

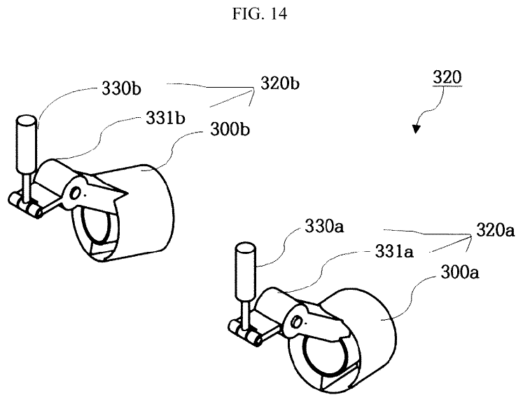

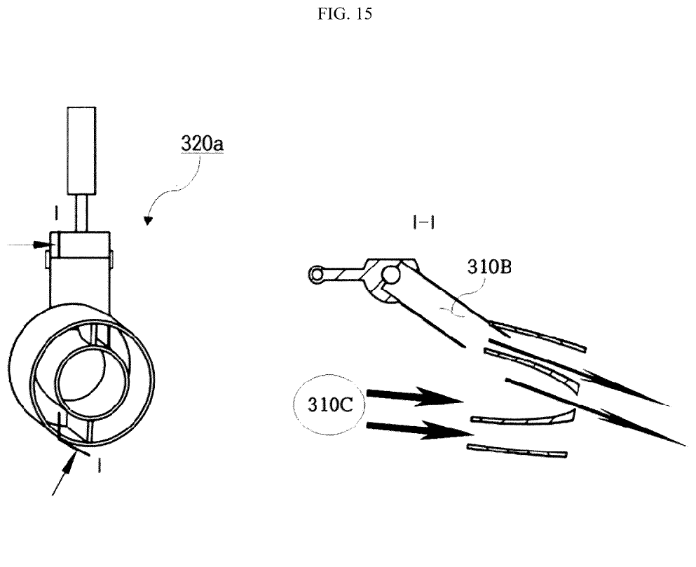

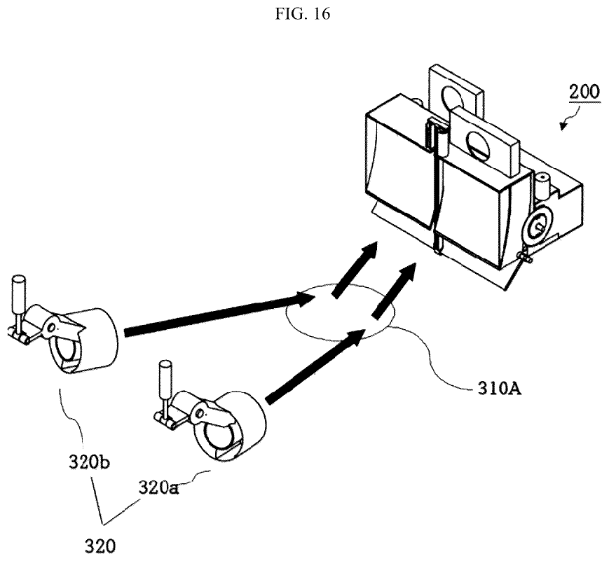

The spraying member will be described. As illustrated in FIGS. 14 to 16, according to the embodiment, the spraying member 320 has a hollow swing arm 331 serving as a passage of a fluid flow. As an upper/lower driving cylinder 330 connected to one end of the swing arm 331 is stretched, the swing arm 331 controls the spraying member 320 to be lowered when the cleaner module is operated and adjusts the road surface target point 310A according to an operating speed or controls raising of the spraying member 320 to facilitate movement of the vehicle when the cleaner module is stopped. The spraying member delivers an air flow discharged when the turbofan 20 generates a vacuum through the passage of the swing arm 331, and amplifies a surrounding air flow or adds wind pressure generated when the vehicle is moved through a shroud 300 provided around the passage, and sprays air to the road surface target point 310A. According to the embodiment, the spraying member 320 may fly an FO on the road surface from the road surface. The flying FO is moved upward by hitting the dustpan 210, and is removed by being suctioned into the filter 30 of the storage tank by a vacuum formed in the inlet 221D or by staying at the first storage tank inlet 221A and moving into the first storage tank 220 when the transfer device 240 is operated, which can increase the performance and the FO removal rate of the cleaner module.

Hereinabove, the embodiments of the present disclosure have been described. One of ordinary skill in the art to which the present disclosure belongs will appreciate that various modifications, equivalents, additions, and substitutions are possible, without departing from the scope and spirit of the present disclosure. Therefore, the disclosed embodiments should be considered in an illustrative aspect rather than a restrictive aspect. The scope of the present disclosure is indicated by the claims rather than the foregoing description, and all differences coming within the scope equivalent thereto should be construed as being included in the present disclosure.

### Industrial Applicability

### Sequence Listing

1. A cleaner module comprising:
a lifting device comprising a slide frame supporting a suction device;
a dustpan configured to control an inclination of an inlet of the suction device;
a transfer device configured to transfer an foreign object (FO);
a first storage tank configured to suction the FO;
a spraying member comprising a shroud;
a swing arm configured to control a position of the spraying member;
an FO sensor;
a controller; and
the suction device.

2. The cleaner module of claim 1, wherein the lifting device allows the suction device to protrude rearward of the storage tank of a vehicle and lowers the suction device.

3. The cleaner module of claim 1, wherein the dustpan is controlled to maintain a distance between the dustpan and a road surface.

4. The cleaner module of claim 3, wherein the dustpan is controlled to be closed when an operation of the device is stopped.

5. The cleaner module of claim 1, wherein the transfer device is disposed between the inlet and the first storage tank, and an upper portion of the transfer device rotates forward.

6. The cleaner module of claim 5, wherein when the transfer device deviates from a stop position, the transfer device is controlled to rotate until reaching a next stop position and then to be stopped.

7. The cleaner module of claim 1, wherein the first storage tank has an inlet that is the transfer device disposed at a side surface and an outlet connected to a turbofan, and when the transfer device is operated, the FO collected at the inlet is suctioned with a vacuum formed in the first storage tank and an upper portion of the transfer device rotating forward.

8. The cleaner module of claim 7, wherein the spraying member amplifies a wind flow of air left when the turbofan generates a vacuum at the first storage tank and the inlet by drawing surrounding air by using the shroud, and sprays the air to a target point of a road surface.

9. The cleaner module of claim 8, wherein the spraying member flies the FO on the road surface so that the FO is moved along the inclination of the dustpan to the inlet.

10. The cleaner module of claim 1, wherein the swing arm is controlled to be lowered when the spraying member is operated, and adjusts a target point of a road surface according to an operation speed of the cleaner module or controls the spraying member to be raised to facilitate movement of the vehicle when the cleaner module is stopped.

11. The cleaner module of claim 7, wherein the transfer device is operated in a period preset by the controller capable of time counting, or operated when the FO sensor detects an FO.

12. The cleaner module of claim 1, wherein the FO sensor is arranged transversely at the inlet and a first storage tank inlet, and when the FO sensor detects a suctioned FO, the controller adds changed values of a receiver.

13. The cleaner module of claim 1, wherein the controller controls the transfer device, the dustpan, and the swing arm by receiving values of the FO sensor and a dustpan position sensor.
